(19) United States
(12) Patent Application Publication
(10) Pub. No.: US 2015/0066360 A1
(43) Pub. Date: Mar. 5, 2015

(54) DASHBOARD DISPLAY NAVIGATION

(71) Applicant: David M. Kirsch, Torrance, CA (US)

(72) Inventor: David M. Kirsch, Torrance, CA (US)

(73) Assignee: HONDA MOTOR CO., LTD., Tokyo (JP)

(21) Appl. No.: 14/018,116

(22) Filed: Sep. 4, 2013

(51) Int. Cl. G01C 21/36; G06F 3/01; G06F 3/041

(52) U.S. Cl. CPC G01C 21/3602; G01C 21/3688; G06F 3/041; G06F 3/017
USPC 701/438; 701/532; 701/468; 345/156; 345/173

(57) ABSTRACT

Systems and methods for providing navigation information are discussed. To increase safety and convenience of use for vehicle navigation devices, a navigation system includes a plurality of displays for displaying related and distinct sets of navigation information in response to an intuitive user input such as a gesture. One such system can include a plurality of display devices, a location determining component for determining a location of a vehicle and other navigation information, and an input component for receiving user input.

### BACKGROUND

In the complicated world of driving and directions, help arrived with the advent of global positioning satellite (GPS) navigation systems. Navigation systems assist drivers in navigating unfamiliar territory with confidence. Physical roadmaps have become tools of the past. Navigation systems help direct drivers to their destinations, with turn-by-turn directions and map displays, and can provide information on points of interest (POIs) such as gas stations, hotels, restaurants, tourist attractions and ATMs.

Navigation systems are capable of providing a wealth of information in a variety of formats. However, the typical display associated with a navigation system presents the user with only one set of information at a time. The user can switch between various modes to search or view a listing of POIs, stored destinations, turn-by-turn directions, map display, traffic prediction data, safety alerts, weather information or other location and route information. Although certain navigation systems make use of a “split-screen” for displaying both a route map and driving directions, traditional techniques for requesting and switching between various sets of navigation information are often tedious and can result in driver distraction. In many instances, the driver is hindered by having to choose between one set of pertinent navigation information or another.

### SUMMARY

The following presents a simplified summary of the disclosure in order to provide a basic understanding of certain aspects of the disclosure. This summary is not an extensive overview of the disclosure. It is not intended to identify key/critical elements of the disclosure or to delineate the scope of the disclosure. Its sole purpose is to present certain concepts of the disclosure in a simplified form as a prelude to the more detailed description that is presented later.

The disclosure disclosed and claimed herein, in one aspect thereof, includes systems and methods that facilitate the display of related navigation information and content on a plurality of display devices associated with a vehicle navigation system. One such system can include a plurality of display devices, a location determining component for determining a location of a vehicle and other navigation information, and an input component for receiving user input. To increase safety and convenience of use for navigation devices installed in automobiles, a navigation system includes a plurality of displays for displaying related sets of navigation information in response to an intuitive user input such as a gesture. Utilizing the disclosed system and methods, a driver can easily access a wide variety of navigation information with minimal effort and distraction.

In an embodiment, in response to a user input, a map including a chosen destination or POI is displayed on a center console touchscreen display. The driver may perform a flicking gesture at the touchscreen and related content, for example, turn-by-turn directions, are displayed at the vehicle meter display located at or near the vehicle's dashboard gage cluster.

In another aspect, the disclosure can include methods for providing related sets of navigation information utilizing a plurality of display devices. One example method can include the acts of receiving a request for navigation information, displaying a first set of navigation information, receiving a gesture input in relation to a second display and displaying a related set of navigation information at the second display. Such a method can also include the acts of receiving a plurality of user inputs and simultaneously displaying related and distinct sets of information on a plurality of display devices.

To the accomplishment of the foregoing and related ends, certain illustrative aspects of the disclosure are described herein in connection with the following description and the annexed drawings. These aspects are indicative, however, of but a few of the various ways in which the principles of the disclosure can be employed and the disclosure is intended to include all such aspects and their equivalents. Other advantages and novel features of the disclosure will become apparent from the following detailed description of the disclosure when considered in conjunction with the drawings.

### BRIEF DESCRIPTION OF THE DRAWINGS

FIG. 1 illustrates navigation information displays associated with a navigation system in accordance with aspects of the disclosure.

FIG. 2 illustrates navigation information displays associated with a navigation system in accordance with aspects of the disclosure.

FIG. 3 illustrates an example flow chart of operations for providing navigation information in accordance with an aspect of the disclosure.

FIG. 4 illustrates a block diagram of a system for providing navigation information in accordance with aspects of the disclosure.

FIG. 5 illustrates an example driver's view of a system for providing navigation information in accordance with an aspect of the disclosure.

### DETAILED DESCRIPTION

The disclosure is now described with reference to the drawings, wherein like reference numerals are used to refer to like elements throughout. In the following description, for purposes of explanation, numerous specific details are set forth in order to provide a thorough understanding of the disclosure. It may be evident, however, that the disclosure can be practiced without these specific details. In other instances, well-known structures and devices are shown in block diagram form in order to facilitate describing the disclosure.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

For the purposes of this disclosure, the terms “driver” and “user” are used interchangeably to refer to a user of the system and method. While in many instances the driver and user are the same entity, it is to be appreciated that a driver, passenger or other user may make use of all or a portion of the features of the disclosed system and method.

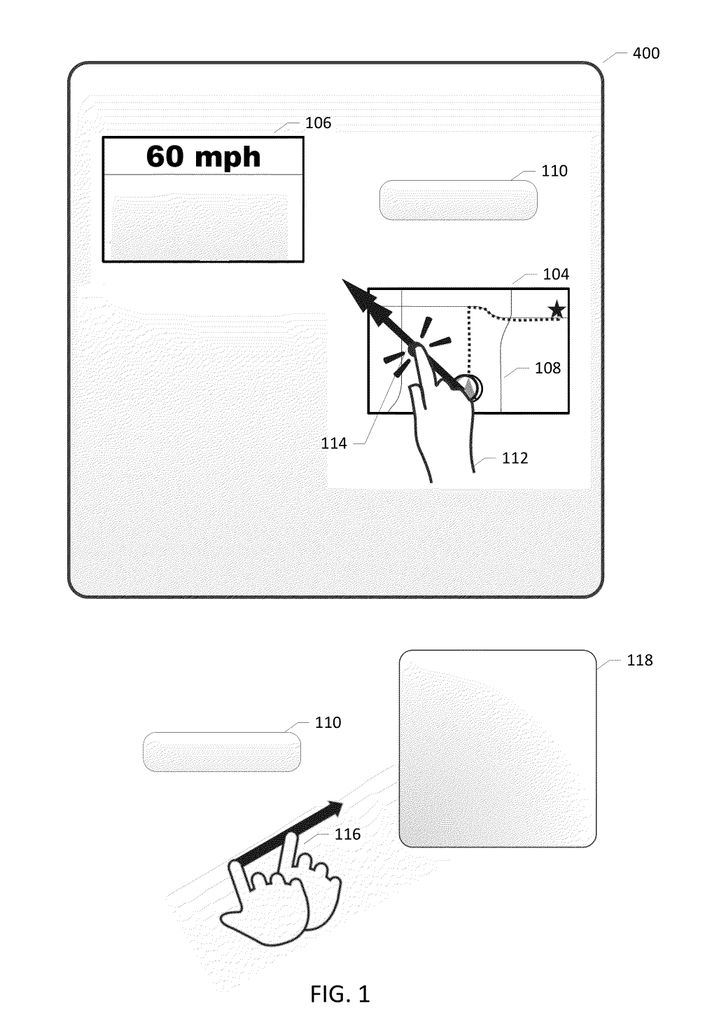

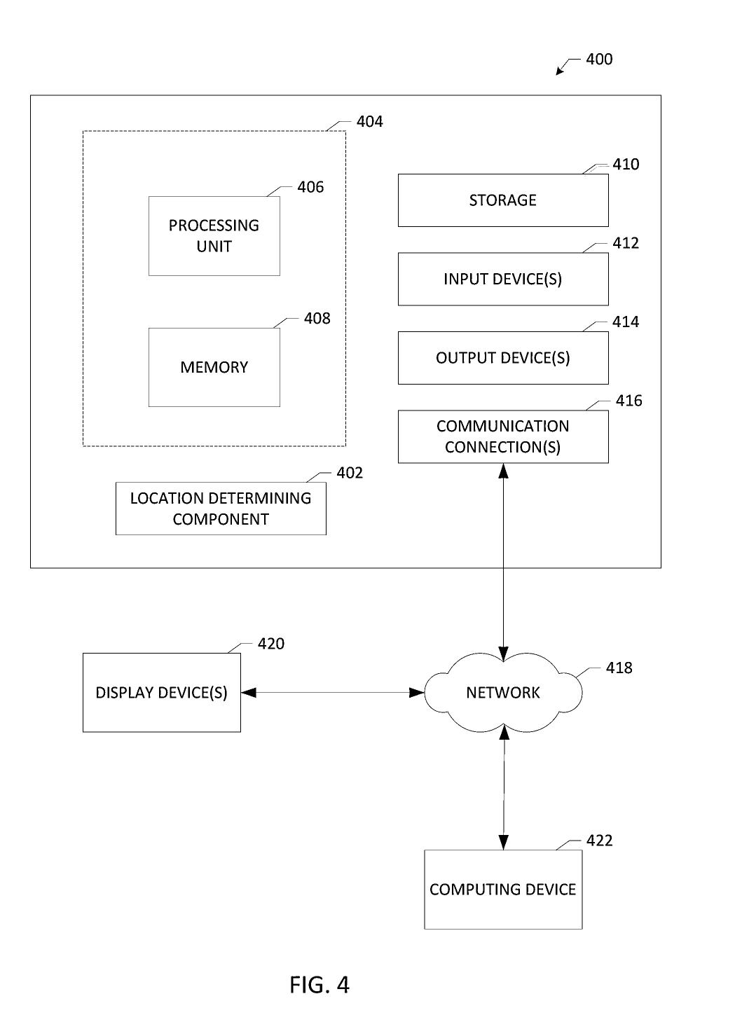

Referring to the drawings, FIG. 1 illustrates a simplified view of a vehicle center console display 104 and meter display 106. For the purposes of this disclosure, a meter display refers to a display located at or near the vehicle dashboard instrument cluster that commonly includes a collection of gages, for example, odometer, speedometer, fuel gage, tachometer, oil pressure, engine coolant temperature and the like. The center console display 104 and meter display 106 are connected to and in communication with a vehicle navigation system 400 (shown in FIG. 4). As a popular transportation tool, many vehicles are equipped with electronics such as global positioning systems (GPS) based navigation according to users' needs. The GPS based navigation system is a mature product in the market. Utilizing a GPS receiver that receives information from GPS satellites to calculate the users' position in real time, together with an electronic map and display screen, users can know their positions, areas, directions and vehicle speed, accurately locate where they are and easily navigate to where they want to go.

In an aspect, center console display 104 includes a touch sensitive screen 108. In an embodiment, the front surface of the center console display 104 may be touch sensitive and capable of receiving input by a user touching the surface of the screen 108. In addition to being touch sensitive, center console display 104 can display navigation information to a user.

In addition to touch sensing, center console display 104 may include areas that receive input from a user without requiring the user to touch the display area of the screen. In an embodiment, a gesture capture component 110 is separate from center console display 104. For example, center console display 104 may be configured to display content to the touch sensitive screen 108, while at least one other area may be configured to receive input via a gesture capture component 110. Gesture capture component 110 includes a gesture capture area (not shown). Gesture capture component 110 can receive input by recognizing gestures made by a user within gesture capture area. Gesture capture and gesture recognition can be accomplished utilizing known gesture capture and recognition systems and techniques including cameras, image processing, computer vision algorithms and the like.

Vehicle navigation system 400 may include other devices for capturing user input, for example, ports, slots and the like. These features may be located on one or more surfaces of the center console display 104 or may be located near the center console display 104. The system 400 may communicate with one or more of these features that may be associated with other devices. For instance, the system 400 may communicate with a smart-phone, tablet, and/or other computer that has been associated with the vehicle to utilize the display and/or features of the other device.

A map including present location, route and destination indicators is displayed on the center console display 104 in response to a user request for navigation information. The driver 112, or other user, may perform a gesture 114 at the touchscreen 104 in relation to the meter display 106, or other display. In response to the gesture, the system displays related navigation information, for example, turn-by-turn directions, route guidance, traffic data, point of interest listing, point of interest information, weather information, safety alert, travel time, present location information, destination or other navigation related information at the meter display 106.

Gesture input 114 can include any action or gesture performed by the driver and recognized by the system 400. The gesture input 114 can be a tapping, dragging, swiping, flicking, or pinching motion of the user's finger or fingers 112 at the touch sensitive screen 108 of center console display 104. A flick gesture may be performed by placing a finger on the touch sensitive screen 108 and quickly swiping it in the desired direction. A tapping gesture can be performed by making a quick up-and-down motion with a finger, lightly striking the touch sensitive screen 108. A pinching gesture may be performed placing two fingers a distance apart on the screen and moving them toward each other without lifting them from the screen.

In aspects, gesture input 114 includes a gesture at a first display with special relation to a second display and/or subsequent displays. Gesture input 114 can include, for example, any of a flicking gesture or other motion in the direction of a second display, a gesture or other motion away from a second display, a gesture or other motion at an angle from or towards a second display, and most any other gesture performed in relation to a second display.

User input can include a three-dimensional gesture 116 captured and recognized by gesture capture component 110. The gesture input 116, in the direction of display 118, can cause the system 400 to display navigation information on display 118 that is related to but different from the navigation information provided at another display within the driver's view.

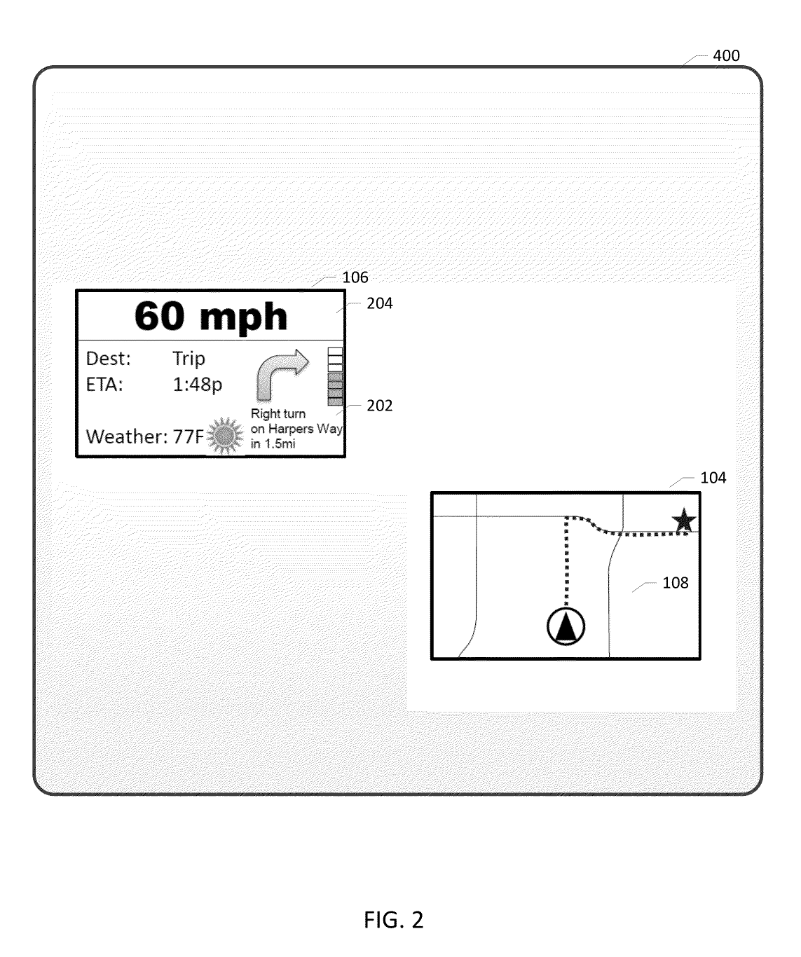

Referring now to FIG. 2, a map including present location, route and destination indicators is displayed on a vehicle center console display 104 based on a user request for navigation information. In response to a gesture, or other user input, the system displays related navigation information 202 on meter display 106. For example, turn-by-turn directions, route guidance, traffic data, point of interest listing, point of interest information, weather information, safety alert, travel time, present location information, destination or other navigation related information can be displayed at the meter display 106. Meter display 106 can include speedometer display 204.

In an embodiment, user input can include a combination of a gesture input and a voice input, for example, the driver may perform a flicking gesture at the at the touch sensitive screen 108 of center console display 104 in the direction of the meter display 106 and issue the voice command “turn-by-turn”. The navigation system 400 displays turn-by-turn directions on the meter display 106 that correspond to the map route provided on display 104.

In accordance with an embodiment, the driver may perform a gesture at the at the touch sensitive screen 108 of center console display 104 with special relation to the meter display 106 while issuing the voice command “turn-by-turn”. For example, the driver may perform a negative velocity gesture (e.g. away from the meter display 106) at the touch sensitive screen 108 with relation to the meter display 106. The navigation system 400 displays turn-by-turn directions on the meter display 106 that correspond to the map route provided on the center console display 104.

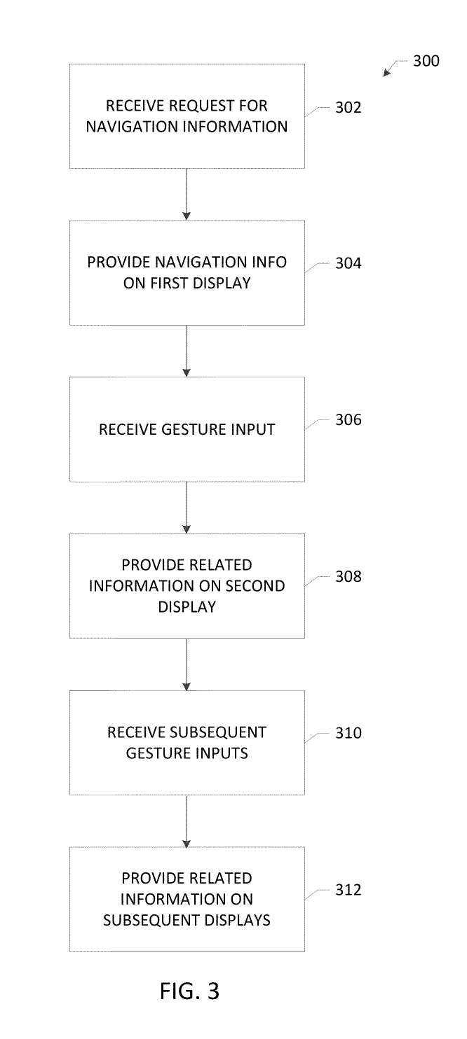

FIG. 3 illustrates a computer implemented method 300 of providing related and distinct sets of navigation information in accordance with aspects of the disclosure. While, for purposes of simplicity of explanation, the one or more methodologies shown herein, e.g., in the form of a flow chart, are shown and described as a series of acts, it is to be understood and appreciated that the disclosure is not limited by the order of acts, as one or more acts may, in accordance with the disclosure, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the disclosure.

Method 300 can begin at 302 by receiving a user intiated request for navigation information. For example, the system 400 receives a user request for driving directions to a particular address. At 304, the navigation system provides a first set of navigation information. For example, in reponse to the user's request for driving directions to a particular address, the system displays a map including a present location, suggested route and destination indicators at a touchscreeen display.

At act 306, the system receives a gesture input from the user. The user may perform a gesture input, e.g. a flicking gesture, at the touchcreeen display. At 308, in response to the user input, the system provides a second set of related but different navigation information at a second display. The system can display, for example, traffic alert information on a meter display in reponse to the flicking gesture input.

At 310, subsequent user inputs (e.g., voice, gesture, touch, motion, etc.) are received by the navigation sytem. At 312, subsequent related sets of navigation information are provided, at subsequent displays within view of the user, in reponse to the subsequent inputs received at 310.

FIG. 4 and the following discussion provide a description of a navigation system and suitable computing environment in which embodiments of one or more of the provisions set forth herein can be implemented.

FIG. 4 illustrates a navigation system 400 including a computing device configured to implement one or more embodiments provided herein. In one configuration, the computing device can include at least one location determining component 402, processing unit 406 and memory 408. Depending on the configuration and type of computing device, memory 408 may be volatile, such as RAM, non-volatile, such as ROM, flash memory, etc., or a combination of the two. This configuration is illustrated in FIG. 4 by dashed line 404.

Location determining component 402 can include most any components for obtaining and providing navigation related information, including but not limited to, GPS antenna, GPS receiver for receiving signals from GPS satellites and detecting location, direction sensor for detecting the vehicle's direction, speed sensor for detecting travel distance, map database, point of interest database, other databases and database information and other associated hardware and software components.

Navigation system 400 can include one or more input devices 412 such as keyboard, mouse, pen, audio or voice input device, touch input device, infrared cameras, video input devices, gesture recognition module, or any other input device.

In embodiments, the system 400 can include additional input devices 412 to receive input from a user. User input devices 412 can include, for example, a push button, touch pad, touch screen, wheel, joystick, keyboard, mouse, keypad, or most any other such device or element whereby a user can input a command to the system. Input devices can include a microphone or other audio capture element that accepts voice or other audio commands. For example, a system might not include any buttons at all, but might be controlled only through a combination of gestures and audio commands, such that a user can control the system without having to be in physical contact with the system.

One or more output devices 414 such as one or more displays 420, including a vehicle center console display, video terminal, projection display, vehicle meter display, heads-up display, speakers, or most any other output device can be included in navigation system 400. The one or more input devices 412 and/or one or more output devices 414 can be connected to navigation system 400 via a wired connection, wireless connection, or any combination thereof. Navigation system 400 can also include one or more communication connections 416 that can facilitate communications with one or more devices including display devices 420, and computing devices 422 by means of a communications network 418.

Communications network 418 can be wired, wireless, or any combination thereof, and can include ad hoc networks, intranets, the Internet, or most any other communications network that can allow navigation system 400 to communicate with at least one other display device 420 and/or computing device 422.

Example display devices 420 include, but are not limited to, a vehicle center console display, touchscreen display, video terminal, projection display, liquid crystal display, vehicle meter display, and heads-up display. For some iterations, this display device may contain application logic for the control and rendering of the experience.

Example computing devices 422 include, but are not limited to, personal computers, hand-held or laptop devices, mobile devices, such as mobile phones, smart phones, Personal Digital Assistants (PDAs), wearable computers, such as Google Glass™, media players, tablets, and the like, multiprocessor systems, consumer electronics, mini computers, distributed computing environments that include most any of the above systems or devices, and the like. Although computing device 422 can be a smart phone for certain users of system 400, computing device 422 can be substantially any computing device, which can include, for example, tablets (e.g. Kindle®, Nook®, Galaxy Note®, iPad®, etc.), cellular/smart phones or PDAs (e.g., Android®, iPhone®, Blackberry®, Palm®, etc.).

The operating environment of FIG. 4 is one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” or modules being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

In these or other embodiments, navigation system 400 can include additional features or functionality. For example, navigation system 400 can also include additional storage such as removable storage or non-removable storage, including, but not limited to, magnetic storage, optical storage, and the like. Such additional storage is illustrated in FIG. 4 by storage 410. In certain embodiments, computer readable instructions to implement one or more embodiments provided herein are in storage 410. Storage 410 can also store other computer readable instructions to implement an operating system, an application program, and the like. Computer readable instructions can be loaded in memory 408 for execution by processing unit 406, for example.

In an aspect, the term “computer readable media” includes computer storage media. Computer storage media includes volatile and nonvolatile, removable and non-removable media implemented in any method or technology for storage of information such as computer readable instructions or other data. Memory 408 and storage 410 are examples of computer storage media. Computer storage media includes, but is not limited to, RAM, ROM, EEPROM, flash memory or other memory technology, CD-ROM, Digital Versatile Disks (DVDs) or other optical storage, or most any other medium which can be used to store the desired information and which can be accessed by the computing device of navigation system 400. Any such computer storage media can be part of navigation system 400.

In an embodiment, computer-readable medium includes processor-executable instructions configured to implement one or more embodiments of the techniques presented herein. Computer-readable data, such as binary data including a plurality of zero's and one's, in turn includes a set of computer instructions configured to operate according to one or more of the principles set forth herein. In one such embodiment, the processor-executable computer instructions is configured to perform a method, such as at least a portion of one or more of the methods described in connection with embodiments disclosed herein. In another embodiment, the processor-executable instructions are configured to implement a system, such as at least a portion of one or more of the systems described in connection with embodiments disclosed herein. Many such computer-readable media can be devised by those of ordinary skill in the art that are configured to operate in accordance with the techniques presented herein.

The term computer readable media includes most any communication media. Communication media typically embodies computer readable instructions or other data in a “modulated data signal” such as a carrier wave or other transport mechanism and includes any information delivery media.

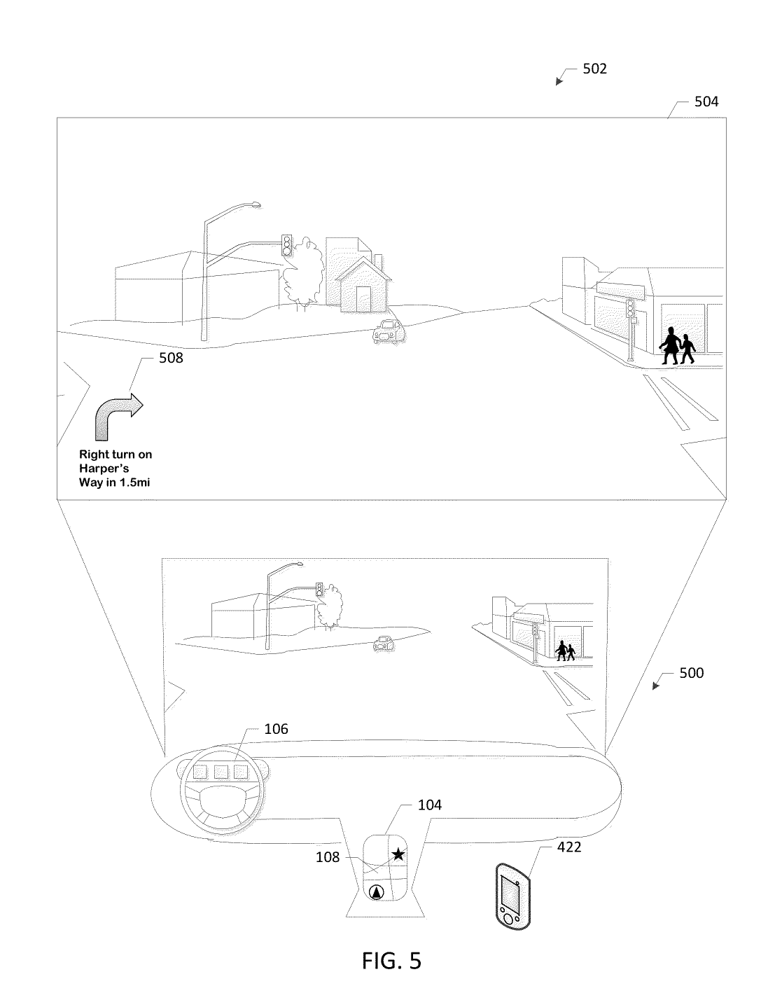

With reference to FIG. 5, in accordance with an embodiment, the disclosure can include a volumetric or three-dimensional heads-up display (HUD) 502, or video display showing a camera view. The disclosure provides a device, system and method for simultaneously providing a driver with related and distinct sets of navigation information. In an embodiment, navigation information is capable of being observed on a HUD within a vehicle or video display. Utilizing the HUD, visual information can be projected into the driver's field of view, creating the possibility for the driver's eyes to remain on the road while information is presented.

Still referring to FIG. 5, an interior portion 500 of a vehicle as viewed by a driver is depicted. The volumetric heads up display 502 creates an overlaid front view 504 that appears to be at one or more focal planes. The overlaid front view 504 projected on the HUD 502 can include turn-by-turn navigation information 508. A navigation map is display on the vehicle center console display 104 and distinct but related navigation and/or POI information may be displayed on the vehicle meter display 106, personal computing device 510 and other display devices within view of the driver. In an embodiment, the vehicle center console display 104 is a touchscreen display.

In an aspect, a user requests navigation information from the navigation system 400 (shown in FIG. 4) at the vehicle center console display 104. For example, the input of a request for directions to a particular point of interest can cause the navigation system 400 to display a map, including indicators of the vehicle's present location, route and chosen destination, at the vehicle center console display 104. The user can perform a flicking gesture in the direction of the meter display 106 at the touchscreen of the vehicle center console display 104. Related but distinct navigation information is displayed at the meter display 106 in response to the input of the flicking gesture.

Similarly, the user can perform a flicking gesture at the touchscreen of the vehicle center console display 104 in the direction of the HUD 502 causing turn-by-turn navigation information 508 to be displayed in the overlaid front view 504 projected on the HUD 502. A subsequent flicking gesture in the direction of the computing device 422 causes additional distinct but related navigation information to be displayed on personal computing device 422. In an aspect, walking directions, point of interest information, tourist information, hours of operation, advertising and most any other navigation information can be displayed at personal computing device 422.

In an embodiment, in response to a user request for navigation information, the navigation system 400 displays a first set of navigation information. A first set of navigation information can include, for example, a map and indicators of the vehicle's present location, route and chosen destination. The navigation system 400 can provide a second set of related and different navigation information at another display at the request of the user. The user may request additional navigation information by inputting a command utilizing, for example, a gesture.

In an aspect, a flicking gesture at the touchscreen 108 of the vehicle center console display 104 causes turn-by-turn directions to be displayed at HUD 502. A second flicking gesture in the direction of the meter display 106 causes any of a map, route guidance, traffic data, point of interest listing, point of interest information, weather information, safety alert, travel time, present location, destination and/or route information to be displayed on the meter display 106.

In accordance with an embodiment, a gesture at the touchscreen 108 of the vehicle center console display 104 causes additional navigation information, for example, walking directions, point of interest hours of operation, POI phone number, tourist information, advertising or most any other information to be displayed at the personal computing device 510.

In an embodiment, the type and placement of the navigation information provided is configurable. For example, the system 400 may be configured to provide related but distinct navigation information at a number of display devices in a particular order. For example, a first gesture input causes navigation information to be displayed at a center console display, a second gesture input causes related navigation information to be displayed at a meter display, a third gesture input causes related navigation information to be displayed or projected onto a HUD, a fourth gesture causes navigation information to be displayed on personal computing device and so on.

In other embodiments, the system 400 can be configured to provide related but distinct navigation information in a particular order. For example, a first gesture input causes map information to be displayed at a first display, a second gesture input causes turn-by-turn directions to be provided at a second display, a third gesture input causes traffic data to be provided at a third display and so on.

In further embodiments, the type of navigation information provided is based on the type of gesture input. For example, turn-by-turn directions are provided at a first display when the system receives a flicking gesture input at the touch screen 108. Traffic alert information is provided at a second display when the system receives a pinching gesture input at the touch screen 108. Estimated travel time, point of interest information, weather information safety alerts, and/or travel time is provided at a third display when the user inputs a double tap gesture.

In still further embodiments, a voice command input may be combined with a gesture input. For example, once a destination or point of interest has been identified and a first set of navigation information provided at the center console display 104, the user may perform a flicking gesture at the touch sensitive screen 108 of center console display 104 in the direction of the HUD 502 and simultaneously input the voice command “traffic alerts”. The navigation system 400 provides traffic alert information corresponding to the map route shown on display 104, on the HUD 502.

In an aspect, once a destination or point of interest has been identified and a first set of navigation information provided at one of the center console display 104, HUD 502 or meter display 106, the user may provide a gesture input, e.g. flicking motion. In response to the gesture input, the navigation system 400 provides POI information at the personal computing device 422. For example, when the chosen POI is a restaurant or retail establishment, the system can display useful information such as restaurant reviews, menu, hours of operation, phone number and the like, at personal computing device 422. In other aspects, walking directions, tourist information, advertising and most any other information of interest can be provided at personal computing device 422.

What has been described above includes examples of the disclosure. It is, of course, not possible to describe every conceivable combination of components or methodologies for purposes of describing the disclosure, but one of ordinary skill in the art may recognize that many further combinations and permutations of the disclosure are possible. Accordingly, the disclosure is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A computer implemented method for providing navigation information, comprising:
utilizing one or more processors and memory storing one or more programs for execution by the one or more processors, the one or more programs including instructions for:
receiving a first user input;
providing a first set of information on a first display in response to the first user input;
receiving a second user input; and
providing a second set of information on a second display in response to the second user input, wherein the second set of information is distinct from and related to the first set of information.

2. The method of providing navigation information of claim 1, including:
receiving a plurality of user inputs; and
providing sets of information on a plurality of displays in response to the plurality of user inputs, wherein the sets of information are distinct from and related to the first set of information, the second set of information and each other.

3. The method of providing navigation information of claim 2, wherein providing sets of information on a plurality of displays comprises simultaneously displaying related information on a vehicle center display, video terminal, projection display, liquid crystal display, vehicle meter display, heads-up display or a personal computing device.

4. The method of providing navigation information of claim 2, wherein providing sets of information on a plurality of displays comprises displaying a map, route guidance, turn-by-turn directions, traffic data, point of interest listing, point of interest information, weather information, safety alert, travel time, present location information or route information.

5. The method of providing navigation information of claim 1, wherein receiving a first user input comprises receiving a request for navigation information.

6. The method of providing navigation information of claim 1, wherein receiving a second user input comprises receiving a gesture input via a touch screen.

7. The method of providing navigation information of claim 1, wherein receiving a second user input comprises receiving a three-dimensional gesture input via a gesture recognition component.

8. The method of providing navigation information of claim 1, wherein receiving a second user input comprises receiving a combination of a gesture input and a voice input.

9. The method of providing navigation information of claim 1, wherein providing a first set of information and providing a second set of information comprises displaying two or more of a map, route guidance, turn-by-turn directions, traffic data, point of interest listing, point of interest information, weather information, safety alert, travel time, present location information and route information.

10. The method of providing navigation information of claim 1, wherein providing the first set information and providing the second set of information comprises simultaneously displaying distinct and related information on two or more of a vehicle center console display, video terminal, projection display, liquid crystal display, vehicle meter display, heads-up display and a personal computing device.

11. A vehicle navigation system comprising:
a plurality of display devices;
an input component for receiving a user input;
a location determining component for determining a location of the vehicle;
a memory operable to store one or more modules; and
a processor operable to execute the one or more modules to determine navigation information and to provide navigation information for display on the display devices based on the user input, wherein the navigation information displayed on each of the plurality of displays is related.

12. The vehicle navigation system of claim 11, including
a first set of navigation information for display on a first display based on a first user input; and
a second set of navigation information for display on a second display based on a second user input, wherein the first and second sets of navigation information are related to and different from each other.

13. The vehicle navigation system of claim 12, wherein the second user input is a gesture input with relation to the second display.

14. The vehicle navigation system of claim 11, wherein the input component comprises a touchscreen or a gesture recognition component and the user input comprises a gesture.

15. The vehicle navigation system of claim 11, wherein the user input comprises a combination of a gesture input and a voice input.

16. The vehicle navigation system of claim 11, wherein the navigation information comprises a map, route guidance, turn-by-turn directions, traffic data, point of interest listing, point of interest information, weather information, safety alert, travel time, present location, destination and route information.

17. The vehicle navigation system of claim 11, wherein each of the plurality of displays is one of a vehicle center console display, video terminal, projection display, vehicle meter display, heads-up display or a personal computing device.

18. A computer implemented method for providing navigation information, comprising:
utilizing one or more processors and memory storing one or more programs for execution by the one or more processors, the one or more programs including instructions for:
receiving a navigation information request from a user;
providing a first set of navigation information on a first display in response to the navigation information request;
receiving a gesture input in relation to a second display from the user; and
providing a second set of navigation information on a second display based on the gesture input, wherein the second set of information is distinct from and related to the first set of information.

19. The method of providing navigation information of claim 18, including
receiving a plurality of gesture inputs from a user; and
simultaneously providing a plurality of distinct but related sets of navigation information on a plurality of displays based on the gesture inputs.

20. The method of providing navigation information of claim 19, wherein providing a plurality of distinct but related sets of navigation information comprises displaying a map, route guidance, turn-by-turn directions, traffic data, point of interest listing, point of interest information, weather information, safety alert, travel time, present location information, destination or route information on a vehicle center console display, video terminal, projection display, liquid crystal display, vehicle meter display, heads-up display or a personal computing device.
